(19) United States
(12) Patent Application Publication
(10) Pub. No.: US 2010/0279007 A1
(43) Pub. Date: Nov. 4, 2010

(54) 3-D Printing of near net shape products

(75) Inventors: Thomas D. Briselden, North East, PA (US); Thomas M. Reilly, Fairview, PA (US); David R. Forsman, Erie, PA (US)

Correspondence Address: John A. Parrish;Law Offices of John A. Parrish, Suite 300, Two Bala Plaza, Bala Cynwyd, PA, 19004, US

(73) Assignees: The Penn State Research Foundation, University Park, PA (US); Storm Development, LLC, Northeast, PA (US)

(21) Appl. No.: 12/228,528

(22) Filed: Aug. 12, 2008

Related U.S. Application Data
(60) Provisional application No. 60/964,710, filed on Aug. 14, 2007.

(51) Int. Cl. B05D 1/06

(52) U.S. Cl. 427/243

(57) ABSTRACT

The disclosed method relates to manufacture of a near net-shaped products such as ceramic containing products such as ceramic-metal composites. The method entails forming a mixture of a build material and a binder and depositing that mixture onto a surface to produce a layer of the mixture. An activator fluid then is applied to at least one selected region of the layer to bond the binder to the build material to yield a shaped pattern. These steps may be repeated to produce a porous whitebody that is heat treated to yield a porous greenbody preform having a porosity of about 30% to about 70%. The greenbody then is impregnated with a molten material such as molten metal. Where the build material is SiC, the molten metal employed is Si to generate a SiC—Si composite.

This application claims priority to U.S. Provisional Application U.S. Ser. No. 60/964,710 filed Aug. 14, 2007.

### FIELD OF THE INVENTION

The invention generally relates to manufacture of near net-shaped products. More specifically, the invention relates to deposition of successive layers of compositions such as ceramic compositions to produce near net shaped ceramic products.

### BACKGROUND OF THE INVENTION

Two well-known methods for producing products by depositing of successive layers include the selective laser sintering (“SLS”) method and the liquid binder method (“LBM”). Both of these methods deposit successive thin cross sections of material to build three-dimensional products.

SLS involves spreading a thin layer of powder onto a flat surface. After the layer is spread onto the surface, a laser is directed onto selected areas of the powder to fuse those areas. Successive layers of powder are spread over previous layers followed by sintering or fusing with the laser to build a 3-dimensional product. SLS, although it has advantages of speed and accuracy, is inhibited by lack of available materials for manufacture of products. SLS also suffers from the requirement to use high-powered lasers.

LBM entails the use of a 3-D printer machine that uses computer-aided design (CAD) data to create a physical prototype of a product. A 3-D printer machine typically employs one or more printer heads to deposit successive layers of material to produce a three dimensional component. To illustrate, a first layer of a material such as plaster is deposited onto a substrate. An adhesive layer that corresponds to a cross-section of the desired product then is deposited over the first layer of the material. When the adhesive dries, a new layer of material that corresponds to another cross section of the component is deposited over the adhesive whereby the adhesive binds the new layer of material to the previously deposited layer of material. This sequence of depositing alternate layers of material and adhesive is repeated to produce a component of a desired shape.

LBM, although useful for manufacture of preforms such as plaster, has not been widely used to produce preforms of ceramic materials. This is due, in part, to the high abrasiveness of the ceramic materials such as SiC on the print heads and other components of the machine. LBM also requires use binders or adhesives in amounts of 10 wt. % or more, which can be detrimental during post processing of components such as ceramic components.

In addition to the forgoing disadvantages, neither SLS nor LBM is capable of producing metal impregnated composites such as siliconized SiC. Manufacture of siliconized SiC composites entails molding a mixture of SiC and binder to produce a SiC preform. The SiC preform then is powder-formed to near-final shape and heated to set the binder to form a green shell. The green shell then is placed in contact with silicon and fired in vacuum so that molten silicon infiltrates the SiC. This known method, however, suffers the disadvantage that special tools must be made for manufacture of specific components.

A need therefore exists for a method that avoids the disadvantages of the prior art methods.

### SUMMARY OF THE INVENTION

The disclosed method relates to manufacture of a near net-shaped product. The method entails mixing a build material and a binder for the build material to produce a mixture of build material and binder, depositing in a first step the mixture of build material and binder onto a surface to produce a layer of the mixture of build material and binder, applying in a second step an activator fluid to at least one selected region of the layer of build material and binder, drying the activator fluid to bond the binder to the build material in the selected region to yield a shaped pattern, treating the whitebody to further set the binder to yield a porous greenbody preform having a porosity of about 30% to about 70%, and contacting the porous greenbody with a molten material for impregnating the porous greenbody preform. The first and second steps are repeated to produce a porous, whitebody preform that may be used in to form of a single layer to generate a greenbody, or may be used in a thickness of more than about one mm. Where ceramic-metal composites are produced, the porous greenbody is placed in contact with powdered metal to form an assembly that is heated to a temperature sufficient to melt the metal so as to cause molten metal to infiltrate the porous greenbody to yield a metal-impregnated greenbody. The metal-impregnated greenbody to then is cooled generate a near net-shaped ceramic metal composite such as siliconized SiC.

The invention advantageously employs greenbodys of very high porosity. The invention enables manufacture of near net shaped ceramic containing components. The components may be readily handled during secondary operations such as thermal processing and metal impregnation to produce ceramic metal composites such as siliconized silicon carbide.

The invention is further described below by reference to the following detailed description and non-limiting examples.

### DETAILED DESCRIPTION OF THE INVENTION

Generally, the disclosed method entails depositing a layer of a mixture of build material and binder (“BMB”) and then applying an activator fluid to the deposited layer to cause the binder to bond the build material. This sequence of steps is repeated to produce a whitebody preform. The whitebody then is treated such as by heating to thermally set the binder to produce a green body preform that may be subjected to additional processing steps such as firing and molten metal impregnation.

### Build Material-Binder Mixtures

### Build Materials

Build materials which may be used in a BMB mixture are solid prior to application of activator fluid, are substantially insoluble in the activator fluid, and give structure to the final product. Build materials that may be employed in a BMB mixture may vary over a wide range of compositions, particle morphologies, and size ranges. Build materials that may be employed include ceramic materials in the form of particles, fibers, or mixtures thereof, metallic materials in the form of particles, fibers, or mixtures thereof, as well as mixtures of other fibers such as glass fibers and graphite fibers with any one or more of ceramic materials and metallic materials.

A wide variety of ceramic materials may be used as build material, including but not limited to aluminates such as calcium aluminate, potassium aluminate, lithium aluminate and mixtures thereof; aluminosilicates such as mullite, zeolites, olivine, clays such as montmorillonite, kaolin, bentonite and mixtures thereof; borides such as titanium diboride, magnesium boride, strontium boride, titanium boride, and mixtures thereof; carbides such as boron carbide, niobium carbide, silicon carbide, titanium carbide, aluminum carbide, tungsten carbide, tantalum carbide, calcium carbide, chromium carbide, zirconium carbide, and mixtures thereof; chlorides such as magnesium chloride, zinc chloride, calcium chloride, and mixtures thereof; glasses such as soda-lime glass, borosilicate glass and mixtures thereof; hydroxides such as magnesium hydroxide, beryllium dihydroxide, cobalt trihydroxide, and mixtures thereof; oxides such as aluminum oxide, barium oxide, beryllium oxide, bismuth oxide, calcium oxide, cobalt oxide, copper oxide, cadmium oxide, chromic oxide, gallium oxide, iron oxide, lead oxide, lithium oxide, magnesium oxide, nickel oxide, silver oxide, silicon oxide, tin oxide, titanium oxide, zinc oxide, zirconium oxide, and mixtures thereof; nitrides such as aluminum gallium nitride, aluminum nitride, borazon, boron nitride, silicon nitride, tantalum nitride, titanium nitride, tungsten nitride, zirconium nitride, gallium nitride, lithium nitride and mixtures thereof; sulfates such as magnesium sulfate, zinc sulfate, potassium metabisulfite, and mixtures thereof, and silicides such as copper silicide, iron silicide, nickel silicide, sodium silicide, magnesium silicide, molybdenum silicide, titanium silicide, tungsten silicide, zirconium silicide, and mixtures thereof. Mixtures of ceramic materials that have one or more of carbides, nitrides, oxides, metals, carbon fibers and wood fibers also may be used as a build material.

Fibers that may be used in build materials have a size that is generally limited to about the thickness of a spread layer of a BMB mixture. Fibers which may be employed include but are not limited to polymeric fibers such as cellulose and cellulose derivatives, substituted or unsubstituted, straight or branched, synthetic polymers such as polypropylene fiber, polyamide flock, rayon, polyvinylalcohol and mixtures thereof; carbide fibers such silicon carbide fiber; silicide fibers such as nickel silicide, titanium silicide and mixtures thereof; aluminosilicate fibers such as mullite fibers, kaolinite fibers and mixtures thereof; oxide fibers such as alumina, zirconia and mixtures thereof; graphite fiber, silica type fibers such as glass fibers and quartz fibers; organic fibers such as cellulose type fibers such as horse hair, wood fibers and mixtures thereof.

Metals that may be used in build materials include but are not limited to aluminum, brass, bismuth, beryllium, chromium, copper, gold, iron, magnesium, nickel, platinum, silicon, silver, stainless steel, steel, tantalum, tin, titanium, tungsten, zinc, and zirconium and mixtures thereof and combinations thereof.

Particles of build material suitable for use in a BMB may vary in morphology from irregular, faceted shapes to spherical shapes. Preferably, the particles are spherically shaped. Generally, the size of particles of build material is smaller than the thickness of the layers to be printed. Typically, particles of build material have a mean diameter of about 5 microns to about 1000 microns, preferably about 20 microns to about 292 microns, more preferably about 70 microns to about 190 microns.

Where ceramic materials are employed as build materials, the particle sizes of the ceramic materials may vary from about 5 microns to about 1000 microns, preferably about 20 microns to about 292 microns, most preferably about 190 microns. Where the ceramic materials are carbides, the particle sizes may vary from about 5 microns to about 1000 microns, preferably about 150 microns to about 190 microns, most preferably about 190 microns. Where the carbide employed as a build material is SiC, the SiC may vary in particle size from about 5 microns to about 400 microns, preferably about 20 microns to about 292 microns, more preferably about 70 microns to about 190 microns. SiC having these particle size characteristics may be obtained from Electrobrasive Materials of Buffalo, N.Y. Where the ceramic materials are nitrides, particle sizes may vary from about 5 microns to about 1000 microns, preferably about 150 microns to about 190 microns, most preferably about 190 microns. Where the nitride is silicon nitride, particle sizes may vary from about 5 microns to about 1000 microns, preferably about 150 microns to about 190 microns, most preferably about 190 microns. Where the ceramic materials are borides, particle sizes may vary from about 5 microns to about 1000 microns, preferably about 150 microns to about 190 microns, most preferably about 190 microns. Where the boride is titanium diboride is employed as a build material, particle sizes may vary from about 5 microns to about 1000 microns, preferably about 150 microns to about 190 microns, most preferably about 190 microns. Where the ceramic materials are oxides, particle sizes may vary from about 5 microns to about 1000 microns, preferably about 150 microns to about 190 microns, most preferably about 190 microns. Where the oxide aluminum oxide is employed as a build material, particle sizes may vary from about 5 microns to about 1000 microns, preferably about 150 microns to about 190 microns, most preferably about 190 microns. Where the ceramic materials are alumino-silicates, particle sizes may vary from about 5 microns to about 1000 microns, preferably about 150 microns to about 190 microns, most preferably about 190 microns. Where the alumino-silicate is mullite, particle sizes may vary from about 5 microns to about 1000 microns, preferably about 150 microns to about 190 microns, most preferably about 190 microns.

Where metals such as aluminum, brass, bismuth chromium, copper, gold, iron, nickel, platinum, silicon, silver, stainless steel, steel, tantalum, tin, titanium, tungsten, zinc, and zirconium, alloys thereof and mixtures thereof are employed as build materials, particle sizes may vary from about 5 microns to about 1000 microns, preferably about 150 microns to about 190 microns, most preferably about 190 microns. Where the metal employed is titanium, particle sizes may vary from about 5 microns to about 1000 microns, preferably about 150 microns to about 190 microns, most preferably about 190 microns.

### Binders

Various binder materials may be admixed with one or more build materials to produce a BMB mixture. Preferred binders typically have high carbon “char” contents of about 20% or more, preferably about 30% to about 50%, most preferably about 50%. The binder employed in a BMB mixture may be a composition or compound selected for one or more of the characteristics of high solubility in the activating fluid, low solution viscosity, low hygroscopicity, and high bonding strength. The binder is typically milled to about 50 microns to about 70 microns prior to admixture with a particulate build material.

The binder employed may be water-soluble, i.e., soluble in an aqueous solvent, soluble in an organic solvent or soluble in mixtures thereof. Water-soluble binders include but are not limited to acrylates, carbohydrates, glycols, proteins, salts, sugars, sugar alcohols, waxes and combinations thereof. Examples of acrylates which may be employed include but are not limited to sodium polyacrylate, styrenated polyacrylic acid, polyacrylic acid, polymethacrylic acid, sodium polyacrylate, sodium polyacrylate copolymer with maleic acid, polyvinyl pyrrolidone copolymer with vinyl acetate, sodium polyacrylate copolymer with maleic acid, polyvinyl alcohol copolymer with polyvinyl acetate, and polyvinyl pyrrolidone copolymer with vinyl acetate, copolymer of octylacrylamidel/acrylatelbutylaminoethyl methacrylate and mixtures thereof.

Examples of carbohydrates which may be employed include but are not limited to polysaccharides such as agar, cellulose, chitosan, carrageenan sodium carboxymethylcellulose, hydroxypropyl cellulose maltodextrin, and combinations thereof; heteropolysaccharides such as pectin; starches such as pregelatinized starch, cationic starch, potato starch, acid-modified starch, hydrolyzed starch, and combinations thereof; gums such as acacia gum, locust bean gum, sodium alginate, gellan gum, gum Arabic, xanthan gum, propylene glycol alginate, guar gum, and combinations thereof. Examples of glycols that may be employed include but are not limited to ethylene glycol, propylene glycol and mixtures thereof. Examples of proteins that may be employed include but are not limited to albumen, rabbit-skin glue, soy protein, and combinations thereof. Examples of sugars and sugar alcohols that may be employed include but are not limited to sucrose, dextrose, fructose, lactose, polydextrose, sorbitol, xylitol, cyclodextrans, and combinations thereof. Other examples of water-soluble compounds which may be used as binders include but are not limited to hydrolyzed gelatin, polyvinyl alcohol, polyethylene oxide, poly(2ethyl-2-oxazoline), polyvinyl pyrrolidone, polyvinyl sulfonic acid, butylated polyvinyl pyrrolidone, sodium polystyrene sulfonate, sulfonated polystyrene, sulfonated polyester, polymers incorporating maleic acid functionalities, and combinations thereof.

Examples of organic solvent, soluble binders which may be used include but are not limited to urethanes, polyamides, polyesters, ethylene vinyl acetates, paraffin, styreneisoprene-isoprene copolymers, styrene-butadiene-styrene copolymers, ethylene ethyl acrylate copolymers, polyoctenamers, polycaprolactones, alkyl celluloses, hydroxyalkyl celluloses, polyethylene/polyolefin copolymers, amaleic anhydride grafted polyethylenes or polyolefins, anoxidized polyethylenes, urethane derivitized oxidized polyethylenes, and thermosetting resins such as phenolic resins such as Durez 5019 from Durez Corp. Other resins that may be employed include but are not limited polyethylene, polypropylene, polybutadiene, polyethylene oxide, polyethylene glycol, polymethyl methacrylate, poly-2-ethyl-oxazoline, polyvinylpyrrolidone, polyacrylamide, and polyvinyl alcohol, phenolic resins and mixtures thereof.

Binders employed in a BMB mixture may include an inorganic solute such as but are not limited to aluminum nitrate, aluminum perchlorate, ammonium bromide, ammonium carbonate, ammonium chloride, ammonium formate, ammonium hydrogen sulfate, ammonium iodide, ammonium nitrate, ammonium selenate, ammonium sulfate, barium nitrate, beryllium nitrate, cadmium chloride, cadmium nitrate, cadmium sulfate, cesium chloride, cesium formate, cesium sulfate, calcium formate, calcium nitrate, calcium nitrite, calcium sulfate, chromium nitrate, chromium perchlorate, cobalt bromide, cobalt chlorate, cobalt nitrate, copper bromide, copper chloride, copper fluorosilicate, copper nitrate, iron bromide, iron fluorosilicate, iron nitrate, iron perchlorate, iron sulfate, lithium azide, lithium bromate, lithium bromide, lithium chloride, lithium chromate, lithium molybdate, lithium nitrate, lithium nitrite, magnesium bromide, magnesium chlorate, magnesium chloride, magnesium chromate, magnesium iodide, magnesium nitrate, manganese bromide, magnesium chloride, manganese fluorosilicate, manganese nitrate, manganese sulfate, nickel bromide, nickel chlorate, nickel chloride, nickel iodide, nickel nitrate, nickel sulfate, potassium acetate, potassium bromide, potassium carbonate, potassium chromate, potassium formate, potassium hydrogen phosphate, potassium hydroxide, potassium iodide, potassium nitrite, potassium selenate, potassium sulfate, silver fluoride, silver nitrate, silver perchlorate, sodium acetate, sodium bromide, sodium chlorate, sodium dichromate, sodium iodide, sodium nitrate, sodium nitrite, sodium perchlorate, sodium polyphosphate, sodium tetraborate, tin bromide, tin chloride, zinc bromide, zinc chlorate, zinc chloride, zinc iodide, zinc nitrate and mixtures thereof.

The amounts of build material and binder in a BMB mixture may vary depending on the specific build material and binder employed. Typically, binder may be present in a BMB mixture an amount of about 0.5 wt. % to about 10 wt. % preferably about 2.5% to about 10% based on the weight of the build material. Where a BMB mixture includes carbides as a build material and a phenolic resin as a binder, the binder may be present in an amount of about 0.5 wt. % to about 5 wt. %, preferably about 2.5% to about 5% most preferably about 5% based on the weight of the carbide. Where a BMB mixture includes SiC as a build material and a phenolic resin as a binder, the binder may be present in an amount of about 0.5 wt. % to about 5 wt. %, preferably about 2.5% to about 5%, most preferably about 5% based on the weight of SiC. Where a BMB mixture includes SiC and sugar, sugar may be present in an amount of from about 1 wt. % to about 10 wt. %, preferably about 8% to about 10%, most preferably about 10% based on the weight of SiC. Where a BMB mixture includes borides as a build material and a phenolic resin as a binder, the binder may be present in an amount of from about 0.5 wt. % to about 5 wt. %, preferably about 2.5% to about 5%, most preferably about 5% based on the weight of the boride. Where a BMB mixture includes borides and sugar, sugar may be present in an amount of about 0.5 wt. % to about 10 wt. %, preferably about 8% to about 10%, most preferably about 10% based on the weight of borides. Where a BMB mixture includes nitrides as a build material and a phenolic resin as a binder, the binder may be present in an amount of from about 0.5 wt. % to about 5 wt. %, preferably about 2.5% to about 5%, most preferably about 5% based on the weight of nitrides. Where a BMB mixture includes aluminosilicates as a build material and a phenolic resin as a binder, the binder may be present in an amount of about 0.5 wt. % to about 5 wt. %, preferably about 2.5% to about 5%, most preferably about 5% based on the weight of aluminosilicates. Where a BMB mixture includes aluminosilicate and sugar, sugar may be present in an amount of about 1 wt. % to about 10 wt. %, preferably about 8% to about 10%, most preferably about 10% based on the weight of aluminosilicate. Where a BMB mixture includes metal as a build material and a phenolic resin as a binder, the binder may be present in an amount of about 0.5 wt. % to about 5 wt. %, preferably about 2.5% to about 5%, most preferably about 5% based on the weight of metal. Where a BMB mixture includes metal and sugar, sugar may be present in an amount of about 1 wt. % to about 10 wt. %, preferably about 8% to about 10%, most preferably about 10% based on the weight of metal.

### Activator Fluid

The activator is selected to achieve a desired solubility of the binder in a BMB mixture. Preferably, the activator is one in which the binder component is highly soluble, and in which the build material is substantially less soluble. The activator may include a mixture of solvents such as where a mixture of binders is employed in the build material-binder mixtures.

Activators for the binder may be in the form of fluids such as liquids and gases. Where gases are employed as an activator fluid, gases may be employed over a wide range of temperatures and pressures. Typically gases may be employed at a temperature of about 100° C. to about 300° C., preferably about 150° C. to about 275° C., more preferably about 230° C. to about 260° C. and at a pressure of about 0.1 PSI to about 5 PSI, preferably about 0.1 PSI to about 1.0 PSI, more preferably about 0.25 PSI.

Activator fluids may vary according to the composition of the binder. Useful activator fluids include but are not limited to water, a lower aliphatic alcohol such as methyl alcohol, ethyl alcohol, isopropanol, or t-butanol, an ester such as ethyl acetate, dimethyl succinate, diethyl succinate, dimethyl adipate, or ethylene glycol diacetate, ketones such as acetone, methyl ethyl ketone, acetoacetic acid and mixtures thereof.

Additives such as amines may be added to the activator fluid to assist in the dissolution of water-miscible binders, such as water-soluble resins. Examples of amines which may be employed include but are not limited to monoisopropanol amine, triethylamine, 2-amine-2-methylI-propanol, 1-amino-2-propanol, 2-dimethylamino-2-methyl-1-propanol, N,N-diethylethanolamine, N-methyldiethanolamine, N,N-dimethylethanolamine, triethanolamine, 2-aminoethanol, 1-[bis[3-(dimethylamino)propyl]amino]-2propanol, 3-amino-1-propanol, 2-(2-aminoethylamino)ethanol, tris(hydroxymethyl)aminomethane, 2-amino-2-ethyl-1,3-propanediol, 2-amino-2-methyl-1,3-propanediol, diethanolamine, 1,3-bis(dimethylamino)-2-propanol, polyethylenimine, and combinations thereof. Other additives which may be employed in an activator fluid include but are not limited to polypropylene glycol, polyethylene glycol, sorbitan trioleate, sorbitan mono-oleate, sorbitan monolaurate, polyoxyethylene sorbitan mono-oleate, soybean oil, mineral oil, propylene glycol and mixtures thereof.

### Impregnates

Metals may be used to impregnate a greenbody formed from a materials such as ceramic materials to yield ceramic metal composites. Metals which may be used include but are not limited to Si, Al, Ti, Ni, Cu, Cr, Bi, Au, Ag, Ta, Sn, Zn, Zr, W, Fe, alloys of Si, Al, and Ti such as brass, as well as Fe—Ni—Cr alloys such as 304, 310, and 330 stainless steel, and Inconel, and mixtures thereof preferably Ti, Ni and most preferably Si.

### Manufacture

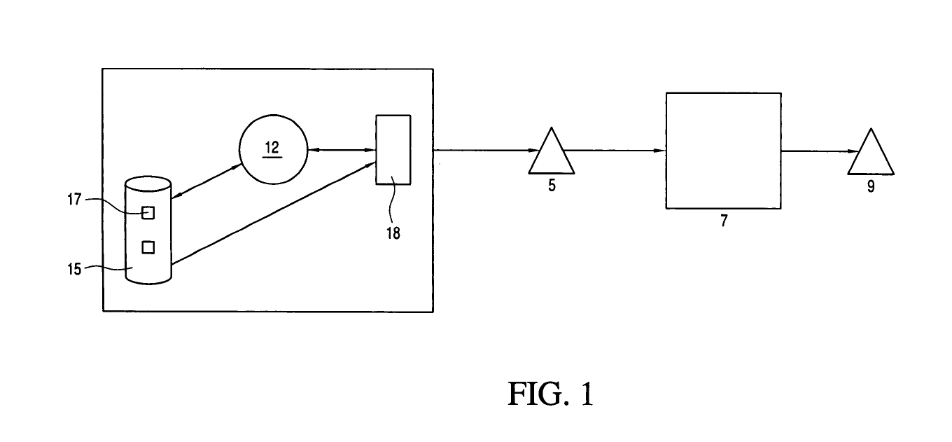

FIG. 1 is a schematic diagram of a system for use in forming a whitebody. As illustrated in FIG. 1, the system includes computer 1 and three-dimensional printer machine such as but not limited to the ZCorp 510 printer machine from Z Corporation. Also shown is formed 3-D whitebody 5, post processing system 7 for treating whitebody 5 to produce a greenbody as well as end product 9. Computer 1 employs software 12, such as a Computer Aided Design (CAD)/Computer Aided Manufacturing (CAM) software. CAD software which may be employed include but are not limited to Pro/ENGINEER from Parametric Technology Co., DESIGNPRINT from IDEAL Scanners and Systems, Inc. and SolidWorks from Dassault Systems, S. A. CAD/CAM software 12 manipulates digital representations 17 of three-dimensional objects stored in a data storage area 15 in computer 1. When a user desires to fabricate a whitebody 5 from a stored representation 17, representation 17 is transmitted to high-level program 18. High-level program 18 divides representation 17 into a plurality of discrete two-dimensional sections and transmits numerical representations of those sections to control electronics 52 in printer machine 3. Printer 3 then prints a layer of BMB that corresponds to the two-dimensional section. An individual layer is printed by first spreading a thin layer of a BMB mixture in a thickness of about 0.089 mm to about 0.305 mm, preferably about 0.203 mm to about 0.254 mm. An activator fluid then is applied to selected regions of the layer to bond build material in those regions to create a desired pattern. The activator fluid then is dried to bond the binder to the build material prior to deposition of a subsequent layer of mixture of build material-binder. The activator fluid may be dried by one of several methods such as heat, UV light, electron beam, a catalyst, or moisture by exposure to ambient air. Preferably, this process is repeated until the desired whitebody is formed. A single layer of BMB, however, after bonding with activator fluid, may be used as a whitebody.

Where the BMB mixture includes SiC and phenolic resin binder, the thickness of the deposited layers of the BMB mixture may be about 0.089 mm to about 0.254 mm, preferably about 0.203 mm to about 0.254 mm, more preferably about 0.254 mm. The activator employed with this type of BMB mixture typically is acetone.

After the whitebody is formed, the binder in the whitebody may be thermally set to produce a greenbody. The binders may be thermally set by heating the whitebody to about 232° C. to about 273° C., preferably about 250° C. to about 273° C., more preferably about 273° C. for about 60 min. to about 300 min., preferably about 200 min. to about 300 min., more preferably about 240 min. The greenbody may be fired such as in a vacuum furnace.

In one aspect, a greenbody such as a SiC green body is fired in a vacuum furnace in the presence of a metal such as Si to impregnate the greenbody to produce a ceramic-metal composite such as siliconized SiC. Other ceramic-metal composites that may be formed in a similar manner include but are not limited to Ti—TiB₂, SiC—Si—Si₃N₄, Al—Al₄C₃ and Al—Al₂O₃. Where the composite is siliconized SiC, SiC is used as the build material to produce the whitebody and subsequent greenbody. Si is used as the metal impregnate. The greenbody may be fired at about 1450° C. to about 1800° C., preferably about 1550° C. to about 1650° C., more preferably about 1600° C. in a vacuum of about 0.1 Torr to about 1 Torr, preferably about 0.1 Torr to about 0.5 Torr, more preferably about 0.1 Torr for about 10 minutes to about 4 hours, preferably about 30 min to about 1.5 hours, more preferably about 45 min to about 1 hour. The amount of Si used to impregnate the greenbody varies according to the weight of the greenbody. Generally, the amount of Si that is used to impregnate a greenbody of SiC may be determined according to formula 1: Si=1.41-0.08 ln [SiC] (1) wherein [SiC] represents the weight of the SiC greenbody. To illustrate, for manufacture of a SiC greenbody that weighs about 200 grams, the amount of Si used to impregnate the greenbody is about 100% by weight of the SiC greenbody part; for a SiC greenbody part which weighs from about 200 grams to about 500 grams, the amount of silicon used is about 80% by weight of the SiC greenbody part; for a SiC greenbody part which weighs more than about 500 grams, the amount of silicon used is about 75% by weight of the SiC greenbody part.

The invention is further illustrated below by reference to the following non-limiting examples.

Examples 1-19 illustrate manufacture of ceramic components such as a heat exchanger block

### Example 1

A numerical model of a heat exchanger block having the dimensions 14 inches long by 8 inches high by 10 inches wide is prepared using DESIGNPRINT software 7.3 from IDEAL Scanners and Systems, Inc. The numerical model is used as input to a Spectrum Z510 rapid prototyping LBM system machine from Z Corporation.

22680 gms of 80 grit SiC build material is combined with 2268 gms sugar binder and mixed in a bucket mixer for 3 hours to produce a BMB mixture. The mixture is added to the Spectrum Z510 rapid prototyping LBM system machine. The Spectrum Z510 rapid prototyping LBM system machine includes a feed bed, a build bed and a printer carriage assembly for supplying liquid activator to the binder.

The BMB mixture of silicon carbide and sugar is supplied to the feed bed of the LBM machine. A roller transfers a portion of the BMB mixture from the feed bed to the build bed of the machine to produce a layer of BMB mixture that has a thickness of 0.254 mm. The printer carriage assembly then moves across the layer to deposit liquid water activator fluid onto the layer of BMB mixture.

Water activator liquid in an amount of is 0.066 ml/gm of the BMB mixture is deposited onto the layer. Air at 38° C. then is passed over the applied activator fluid for 5 min to evaporate the water and bind the sugar to the SiC particles. This sequence of steps is repeated 400 times to produce a whitebody that measures 4 inches thick, 4 inches wide and 12 inches long. The whitebody then is embedded in 80 grit silicon and heated to 260° C. for 3 hours to thermally set the binder and to produce a greenbody of silicon carbide that weighs 1077 grams.

### Example 2

The method of example 1 performed except that 1134 gms of Durez 5019 phenolic resin is employed as binder, acetone activator fluid in an amount of 0.132 ml/gm of the BMB mixture is employed, and drying of the applied activator fluid is performed at 38° C. for 3 min.

### Example 3

The method of example 1 performed except that a mixture of 454 gms of Durez 5019 phenolic resin and 1361 gms of sugar is employed as binder, a mixture of 80 wt. % water and 20 wt. % acetone is employed as activator fluid, the activator fluid is applied in an amount of 0.088 ml/gm of the BMB mixture, and drying of the applied activator fluid is performed at 38° C. for 5 min.

### Example 4

The method of example 1 is repeated except that steam is used as the activator fluid and is applied for 0.5 sec and drying is performed at 38° C. for 2 min.

### Example 5

The method of example 1 is repeated except that Si₃N₄ is substituted for SiC, and firing is performed at 1650° C. for 15 min under a vacuum of 0.1 Torr followed by a nitrogen-atmosphere soak performed at 1500° C. for 15 min under a vacuum of 254 Torr.

### Example 6

The method of example 5 performed except that 1134 gms of Durez 5019 phenolic resin is employed as binder, acetone activator fluid in an amount of 0.132 ml/gm of the BMB mixture is employed, and drying of the applied activator fluid is performed at 38° C. for 3 min.

### Example 7

The method of example 5 performed except that a mixture of 454 gms of Durez 5019 phenolic resin and 1361 gms of sugar is employed as binder, a mixture of 80 wt. % water and 20 wt. % acetone is employed as activator fluid. The activator fluid is applied in an amount of 0.088 ml/gm of the BMB mixture, and drying of the applied activator fluid is performed at 38° C. for 5 min.

### Example 8

The method of example 1 is repeated except that TiB₂ is substituted for SiC, Ti is substituted for Si and firing is performed at 1850° C. for 20 min under a vacuum of 0.1 Torr.

### Example 9

The method of example 8 performed except that 1134 gms of Durez 5019 phenolic resin is employed as binder, acetone activator fluid in an amount of 0.132 ml/gm of the BMB mixture is employed, and drying of the applied activator fluid is performed at 38° C. for 5 min.

### Example 10

The method of example 8 performed except that a mixture of 454 gms of Durez 5019 phenolic resin and 1361 gms of sugar is employed as binder, a mixture of 80 wt. % water and 20 wt. % acetone is employed as activator fluid. The activator fluid is applied in an amount of 0.088 ml/gm of the BMB mixture, and drying of the applied activator fluid is performed at 38° C. for 5 min.

### Example 11

The method of example 1 is repeated except that alumina is substituted for SiC, Al is substituted for Si and firing is performed at 1400° C. for 15 min under a vacuum of 0.1 Torr.

### Example 12

The method of example 11 performed except that 1134 gms of Durez 5019 phenolic resin is employed as binder, acetone activator fluid in an amount of 0.132 ml/gm of the BMB mixture is employed, and drying of the applied activator fluid is performed at 38° C. for 3 min.

### Example 13

The method of example 11 performed except that a mixture of 454 gms of Durez 5019 phenolic resin and 1361 gms of sugar is employed as binder, a mixture of 80 wt. % water and 20 wt. % acetone is employed as activator fluid. The activator fluid is applied in an amount of 0.088 ml/gm of the BMB mixture, and drying of the applied activator fluid is performed at 38° C. for 5 min.

### Example 14

The method of example 1 is repeated except that aluminum carbide is substituted for SiC, Al is substituted for Si and firing is performed at 1400° C. for 15 min under a vacuum of 0.1 Torr.

### Example 15

The method of example 14 performed except that 1134 gms of Durez 5019 phenolic resin is employed as binder, acetone activator fluid in an amount of 0.132 ml/gm of the BMB mixture is employed, and drying of the applied activator fluid is performed at 38° C. for 3 min.

### Example 16

The method of example 14 performed except that a mixture of 454 gms of Durez 5019 phenolic resin and 1361 gms of sugar is employed as binder, a mixture of 80 wt. % water and 20 wt. % acetone is employed as activator fluid. The activator fluid is applied in an amount of 0.088 ml/gm of the BMB mixture, and drying of the applied activator fluid is performed at 38° C. for 5 min.

### Example 17

The method of example 1 is repeated except that mullite is substituted for SiC, Al is substituted for Si and firing is performed at 1400° C. for 15 min under a vacuum of 0.1 Torr.

### Example 17a

The method of example 17 is repeated except that it is not infiltrated. Instead, it is sintered at a temperature of 1650° C. for 1 hour under a vacuum of 0.1 Torr to produce a final porous part.

### Example 17b

The method of example 17a is repeated except that the BMB is comprised of 17010 gms 80 grit mullite, 3402 gms 220 grit mullite, 2268 gms 440 grit mullite, and 2268 gms sugar to produce a significantly less porous part.

### Example 17c

The method of example 17a is repeated except that the BMB is comprised of 17010 gms 80 grit mullite, 3402 gms 220 grit mullite, 2268 gms 440 grit mullite, and 2268 gms powdered clay, the powdered clay acting as the binder and using 100% water as an activator fluid. The activator fluid is applied in an amount of 0.290 ml/gm of the BMB mixture, and drying of the applied activator fluid is performed at 38° C. for 5 min.

### Example 18

The method of example 17 performed except that 1134 gms of Durez 5019 phenolic resin is employed as binder, acetone activator fluid in an amount of 0.132 ml/gm of the BMB mixture is employed, and drying of the applied activator fluid is performed at 38° C. for 3 min.

### Example 19

The method of example 17 performed except that a mixture of 454 gms of Durez 5019 phenolic resin and 1361 gms of sugar is employed as binder, a mixture of 80 wt. % water and 20 wt. % acetone is employed as activator fluid. The activator fluid is applied in an amount of 0.088 ml/gm of the BMB mixture, and drying of the applied activator fluid is performed at 38° C. for 5 min.

Examples 20-25 illustrate manufacture of metal impregnated ceramic composites

### Example 20

730 grams of Si is placed in contact with the greenbody formed as in example 1 and induction fired in a furnace equipped with a graphite susceptor. Firing is performed under a vacuum of 0.00197 atm at a ramp rate of 2500° C./hr for 40 minutes to reach 1650° C., which is then held at temperature and pressure for 15 min to produce a siliconized SiC heat exchanger block.

### Example 21

730 grams of Si is placed in contact with the Si₃N₄ greenbody formed as in example 5 and induction fired in a furnace equipped with a graphite susceptor. Firing is performed under a vacuum of 0.00197 atm at a ramp rate of 2500° C./hr for 40 minutes to reach 1650° C., which is then held at temperature and pressure for 15 min to allow for infiltration. The temperature is then cooled to 1500° C. and then held for 15 min in a nitrogen environment under a pressure of 0.334 atm.

### Example 22

730 grams of Si is placed in contact with the TiB₂ greenbody formed as in example 8 and induction fired in a furnace equipped with a graphite susceptor. Firing is performed under a vacuum of 0.00197 atm at a ramp rate of 2500° C./hr for 40 minutes to reach 1650° C., which is then held at temperature and pressure for 15 min.

### Example 23

900 grams of Al is placed in contact with the alumina greenbody weighing 1325 grams formed as in example 11 and induction fired in a furnace equipped with a graphite susceptor. Firing is performed under a vacuum of 0.00197 atm at a ramp rate of 2500° C./hr for 34 minutes to reach 1400° C., which is then held at temperature and pressure for 15 min.

### Example 24

900 grams of Al is placed in contact with the aluminum carbide greenbody weighing 790 grams formed as in example 14 and induction fired in a furnace equipped with a graphite susceptor. Firing is performed under a vacuum of 0.00197 atm at a ramp rate of 2500° C./hr for 34 minutes to reach 1400° C., which is then held at temperature and pressure for 15 min.

### Example 25

900 grams of Al is placed in contact with the mullite greenbody weighing 936 grams formed as in example 17 and induction fired in a furnace equipped with a graphite susceptor. Firing is performed under a vacuum of 0.00197 atm at a ramp rate of 2500° C./hr for 34 minutes to reach 1400° C., which is then held at temperature and pressure for 15 min.

1. A method of manufacture of a near net-shaped product comprising,
mixing a build material and a binder for the build material to produce a mixture of build material and binder,
depositing in a first step the mixture of build material and binder onto a surface to produce a layer of the mixture of build material and binder,
applying in a second step an activator fluid to at least one selected region of the layer of build material and binder,
drying the activator fluid to bond the binder to the build material in the selected region to yield a whitebody having a shaped pattern,
treating the whitebody to further set the binder to yield a porous greenbody preform having a porosity of about 30% to about 70%,
contacting the porous greenbody with a molten material for impregnating the porous greenbody preform.

2. The method of claim 1 wherein the first and second steps are repeated to produce a porous, whitebody preform having a thickness of more than about one mm.

3. The method of claim 1 wherein the build material is selected from the group consisting of ceramics, metals and mixtures thereof.

4. The method of claim 1 wherein the build material is a ceramic selected from the group consisting of aluminates, aluminosilicates, borides, carbides, chlorides, glasses, hydroxides, oxides, nitrides, sulfates, silicides and mixtures thereof.

5. The method of claim 1 wherein the build material is a metal is selected from the group consisting of aluminum, brass, bismuth, beryllium, chromium, copper, gold, iron, magnesium, nickel, platinum, silicon, silver, stainless steel, steel, tantalum, tin, titanium, tungsten, zinc, and zirconium and mixtures thereof.

6. The method of claim 3 wherein the ceramic is SiC.

7. The method of claim 1 wherein the binder material is selected from group consisting of water-soluble binders, organic solvent soluble binders and mixtures thereof.

8. The method of claim 6 wherein the binder is sugar, the activator fluid is water and the molten material is Si.

9. The method of claim 8 wherein the greenbody has a porosity of about 45% to about 55%.

10. The method of claim 1 wherein the binder is a water soluble binder selected from the group consisting of acrylates, carbohydrates, glycols, proteins, salts, sugars, sugar alcohols, waxes and combinations thereof.

11. The method of claim 1 wherein the binder is a organic solvent soluble binder selected from the group consisting of urethanes, polyamides, polyesters, ethylene vinyl acetates, paraffin, styreneisoprene-isoprene copolymers, styrene-butadiene-styrene copolymers, ethylene ethyl acrylate copolymers, polyoctenamers, polycaprolactones, alkyl celluloses, hydroxyalkyl celluloses, polyethylene/polyolefin copolymers, amaleic anhydride grafted polyethylenes or polyolefins, anoxidized polyethylenes, urethane derivitized oxidized polyethylenes, and thermosetting resins.

12. A method of manufacture of a near net-shaped ceramic-metal composite product comprising,
mixing a build material and a binder for the build material to produce a mixture of build material and binder,
depositing in a first step the mixture of build material and binder onto a surface to produce a layer of the mixture of build material and binder,
applying in a second step an activator fluid to at least one selected region of the layer of build material and binder,
drying the activator fluid to bond the binder to the build material in the selected region to yield a whitebody having a shaped pattern,
treating the whitebody to further set the binder to yield a porous greenbody preform having a porosity of about 30% to about 70%,
contacting the porous greenbody with powdered metal to form an assembly,
heating the assembly to a temperature sufficient to melt the metal so as to cause molten metal to infiltrate the porous greenbody to yield a metal-impregnated preform, and
cooling the metal-impregnated preform to generate a near net-shaped ceramic metal composite.

13. The method of claim 12 wherein the build material is selected from the group consisting of ceramics, metals and mixtures thereof.

14. The method of claim 12 wherein the build material is a ceramic selected from the group consisting of aluminates, aluminosilicates, borides, carbides, chlorides, glasses, hydroxides, oxides, nitrides, sulfates, silicides and mixtures thereof.

15. The method of claim 12 wherein the build material is a metal is selected from the group consisting of aluminum, brass, bismuth, beryllium, chromium, copper, gold, iron, magnesium, nickel, platinum, silicon, silver, stainless steel, steel, tantalum, tin, titanium, tungsten, zinc, and zirconium and mixtures thereof.

16. The method of claim 12 wherein the build material is SiC.

17. The method of claim 12 wherein the binder material is selected from group consisting of water-soluble binders, organic solvent soluble binders and mixtures thereof.

18. The method of claim 16 wherein the binder is sugar, the activator fluid is liquid water and the metal is Si.

19. The method of claim 18 wherein the greenbody has a porosity of about 45% to about 55%.

20. The method of claim 12 wherein the binder is a water soluble binder selected from the group consisting of acrylates, carbohydrates, glycols, proteins, salts, sugars, sugar alcohols, waxes and combinations thereof.

21. The method of claim 12 wherein the binder is a organic solvent soluble binder selected from the group consisting of urethanes, polyamides, polyesters, ethylene vinyl acetates, paraffin, styreneisoprene-isoprene copolymers, styrene-butadiene-styrene copolymers, ethylene ethyl acrylate copolymers, polyoctenamers, polycaprolactones, alkyl celluloses, hydroxyalkyl celluloses, polyethylene/polyolefin copolymers, amaleic anhydride grafted polyethylenes or polyolefins, anoxidized polyethylenes, urethane derivitized oxidized polyethylenes, and thermosetting resins.

22. A method of manufacture of a near net-shaped siliconized-silicon carbide composite product comprising,
mixing SiC and sugar to produce a build material mixture,
depositing in a first step the build material mixture onto a surface to produce a layer of build material mixture,
applying in a second step an activator fluid in the form of water to at least one selected region of the layer of build material mixture,
drying the activator fluid to bond the sugar to the SiC in the selected region to yield a whitebody having a shaped pattern,
treating the whitebody to further set the binder to yield a porous greenbody preform having a porosity of about 30% to about 70%,
contacting the porous greenbody with an amount of powdered Si to form an assembly wherein the amount of Si contacting the porous greenbody is equal to Si=1.41-0.08 ln [SiC] wherein [SiC] represents the weight of the SiC greenbody,
firing the assembly under vacuum to cause molten Si to infiltrate the porous greenbody to yield Si-impregnated SiC, and
cooling the metal-impregnated greenbody to generate a near net-shaped Si—SiC composite.

23. The method of claim 22 wherein the water is in the form of steam.

24. The method of claim 22 wherein the firing is performed at 1650° C.
